(19) United States
(12) Patent Application Publication
(10) Pub. No.: US 2025/0164807 A1
(43) Pub. Date: May 22, 2025

(54) WEARABLE ELECTRONIC DEVICE COMPRISING LENS BARREL

(71) Applicant: Samsung Electronics Co., Ltd., Suwon-si (KR)

(72) Inventors: Yongkoo HER, Suwon-si (KR); Kiwoo KIM, Suwon-si (KR); Seoungyong PARK, Suwon-si (KR); Hongkook LEE, Suwon-si (KR); Euntaek JANG, Suwon-si (KR)

(21) Appl. No.: 19/032,906

(22) Filed: Jan. 21, 2025

Related U.S. Application Data
(63) Continuation of application No. PCT/KR2023/010746, filed on Jul. 25, 2023.

(30) Foreign Application Priority Data
Jul. 25, 2022 (KR) 10-2022-0091650
Sep. 6, 2022 (KR) 10-2022-0113020

(51) Int. Cl. G02B 27/01; G02B 7/02; G02B 27/09

(52) U.S. Cl. CPC G02B 27/0172; G02B 7/028; G02B 27/0149; G02B 27/0955; G02B 2027/0178

(57) ABSTRACT

A wearable electronic device is provided. The wearable electronic device includes a housing including at least one opening, an optical unit positioned in the at least one opening, a display module configured to project, on the optical unit, image information, a lens barrel comprising a lens unit disposed to face the display module so as to guide, to the optical unit, the image information generated from the display module, wherein the lens barrel is disposed between the optical unit and the display module and a conductive member disposed on one surface of the lens barrel to be electrically connected to a power wire of the display module.

### CROSS-REFERENCE TO RELATED APPLICATION(S)

This application is a continuation application, claiming priority under § 365(c), of an International application No. PCT/KR2023/010746, filed on Jul. 25, 2023, which is based on and claims the benefit of a Korean patent application number 10-2022-0091650, filed on Jul. 25, 2022, in the Korean Intellectual Property Office, and of a Korean patent application number 10-2022-0113020, filed on Sep. 6, 2022, in the Korean Intellectual Property Office, the disclosure of each of which is incorporated by reference herein in its entirety.

### BACKGROUND

### 1. Field

The disclosure relates to a wearable electronic device including a lens barrel.

### 2. Description of Related Art

A wearable electronic device may include augmented reality (AR) glasses or smart glasses in the form of eyeglasses that implement various content on a transparent glass member (e.g., lenses).

The wearable electronic device may be configured such that a plurality of rims (e.g., eyeglass frames) and temples (e.g., eyeglass arms) are connected via hinges, and the temples are folded or unfolded relative to the rims.

The above information is presented as background information only to assist with an understanding of the disclosure. No determination has been made, and no assertion is made, as to whether any of the above might be applicable as prior art with regard to the disclosure.

### SUMMARY

A wearable electronic device may implement augmented reality by projecting image information from a display onto a transparent glass (e.g., an optical unit) through which external reality is visually recognized. The display may need to be maintained at high brightness in order to deliver the image information more clearly to a user. As a current flowing through a wire of the display increases to implement high brightness of the display, a voltage drop across wire resistance may increase. In this case, considering the voltage drop value, the power consumption of the display may increase as the driving voltage of the display increases.

Meanwhile, when implementing the high brightness of the display, heat may be generated in the display panel. The heat generated in the panel of the display may reduce the driving efficiency of the display panel. Accordingly, the display may require higher driving power to maintain the high brightness, which may result in an increase in heat generation of the display.

Aspects of the disclosure are to address at least the above-mentioned problems and/or disadvantages and to provide at least the advantages described below. Accordingly, an aspect of the disclosure is to provide a structure that implements and maintains high brightness in the display while reducing power consumption and heat generation of the display.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a housing including at least one opening, an optical unit positioned in the at least one opening, a display module configured to project, on the optical unit, image information, a lens barrel including a lens unit disposed to face the display module so as to guide, to the optical unit, the image information generated from the display module, wherein the lens barrel is disposed between the optical unit and the display module, and a conductive member disposed on one surface of the lens barrel to be electrically connected to a power wire of the display module.

In accordance with another aspect of the disclosure, a wearable electronic device is provided. The wearable electronic device includes a housing including at least one opening, an optical unit positioned in the at least one opening, a display module configured to project, on the optical unit, image information, and a lens barrel disposed between the display module and the optical unit, the lens barrel including a lens unit disposed to face the display module and configured to guide the image information generated by the display module to the optical unit, and at least one hole formed on one surface of the lens barrel.

According to various embodiments disclosed in this document, it is possible to provide a structure that implements high brightness in the display while reducing power consumption and heat generation of the display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a perspective view of a wearable electronic device according to an embodiment of the disclosure;

FIG. 3 is an exploded perspective view of a wearable electronic device according to an embodiment of the disclosure;

FIG. 4 is a cross-sectional view of a portion of a wearable electronic device taken along line 4-4 of FIG. 2 according to an embodiment of the disclosure;

FIG. 5 is a view illustrating an implementation of augmented reality using a wearable electronic device according to an embodiment of the disclosure;

FIG. 6 illustrates a cross-sectional view taken along line A-A′ in FIG. 2 and a view illustrating a state in which a conductive member is disposed on a rear surface of a lens barrel according to an embodiment of the disclosure;

FIG. 7 is a cross-sectional view taken along line A-A′ in FIG. 2, in which a conductive member disposed on a side surface of a lens barrel is illustrated according to an embodiment of the disclosure;

FIG. 8A illustrates a cross-sectional view taken along a line A-A′ in FIG. 2, and a plan view illustrating a rear surface of a lens barrel according to an embodiment of the disclosure;

FIGS. 8B and 8C are cross-sectional views taken along a line A-A′ in FIG. 2, illustrating a state in which holes are formed on a side surface of a lens barrel according to various embodiments of the disclosure;

FIG. 9 illustrates a front view of a hole of a lens barrel and a view illustrating a state in which a porous material is disposed in a hole of a lens barrel according to an embodiment of the disclosure;

FIG. 10 is a cross-sectional view taken along line A-A′ in FIG. 2, illustrating a blocking member covering a hole of a lens barrel according to an embodiment of the disclosure; and

FIGS. 11A and 11B illustrate a plan view illustrating a rear surface of a lens barrel, and a view illustrating a state in which a conductive member is disposed on the rear surface of the lens barrel, and a hole is formed on a side surface of the lens barrel according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

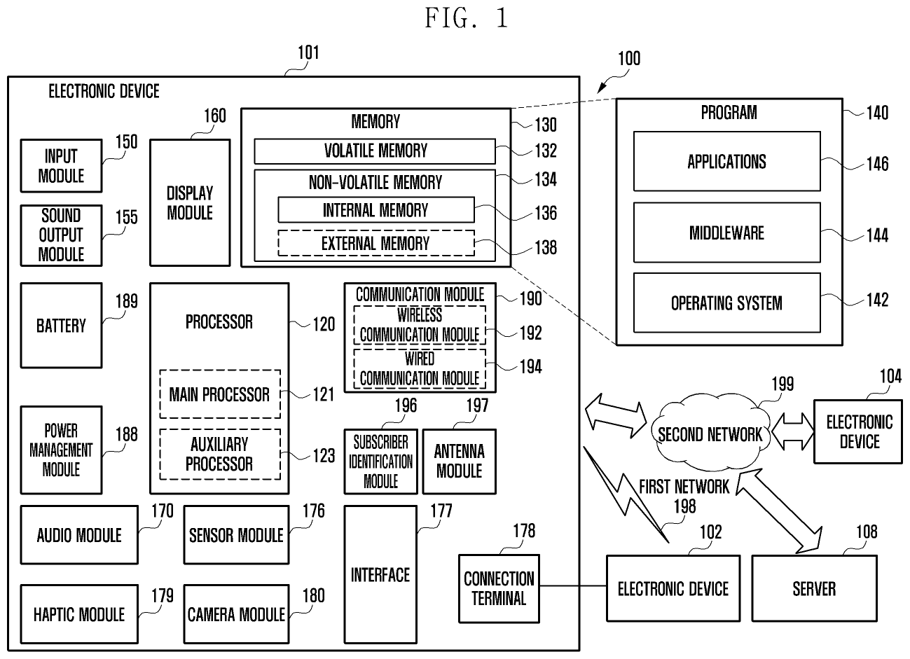

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element composed of a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197. According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

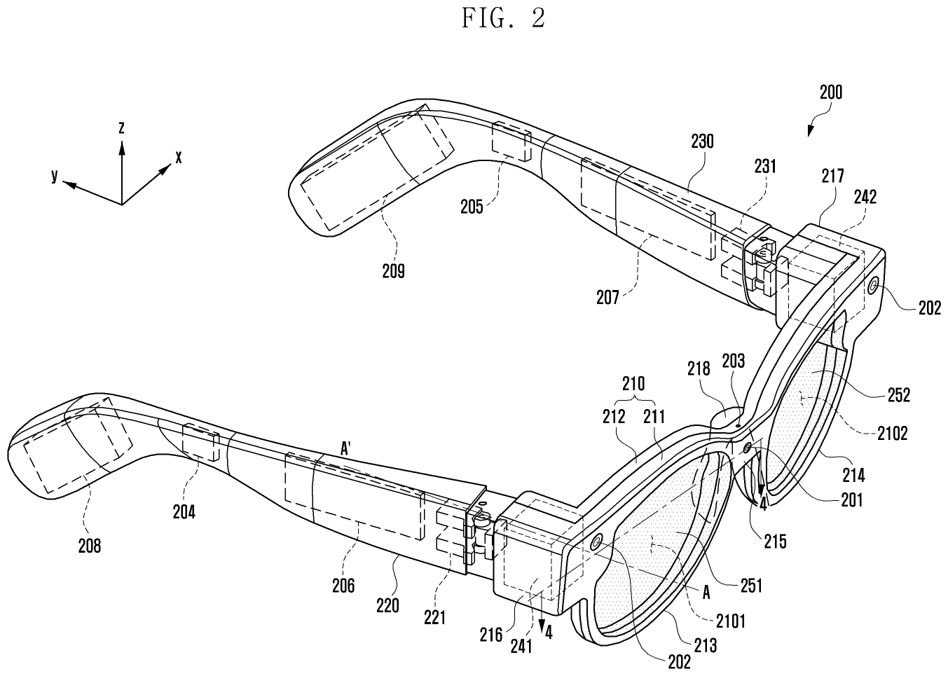

FIG. 2 is a perspective view of a wearable electronic device according to an embodiment of the disclosure.

Referring to FIG. 2, a wearable electronic device may be at least partially similar to the electronic device 101 of FIG. 1 or may further include other embodiments of the electronic device.

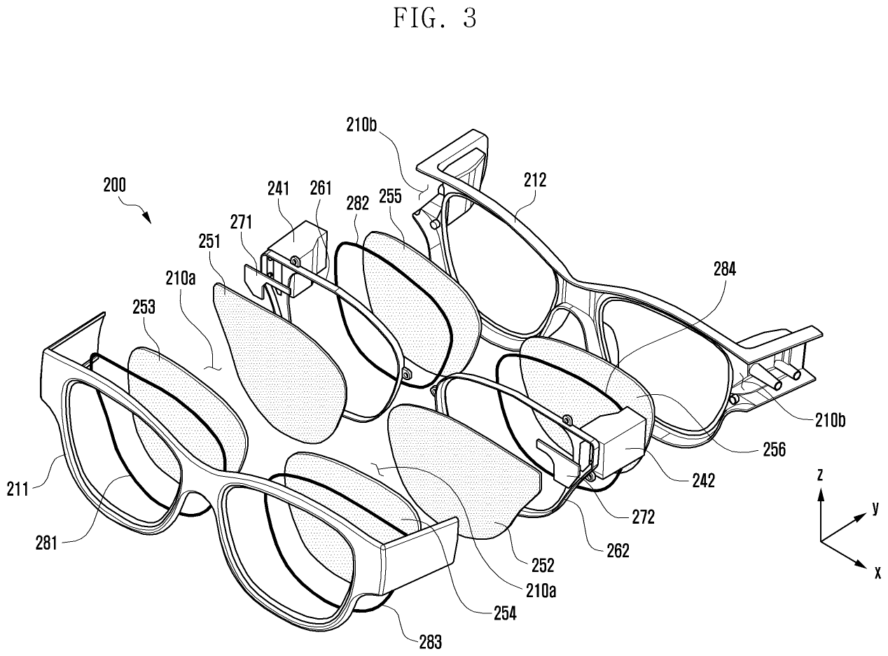

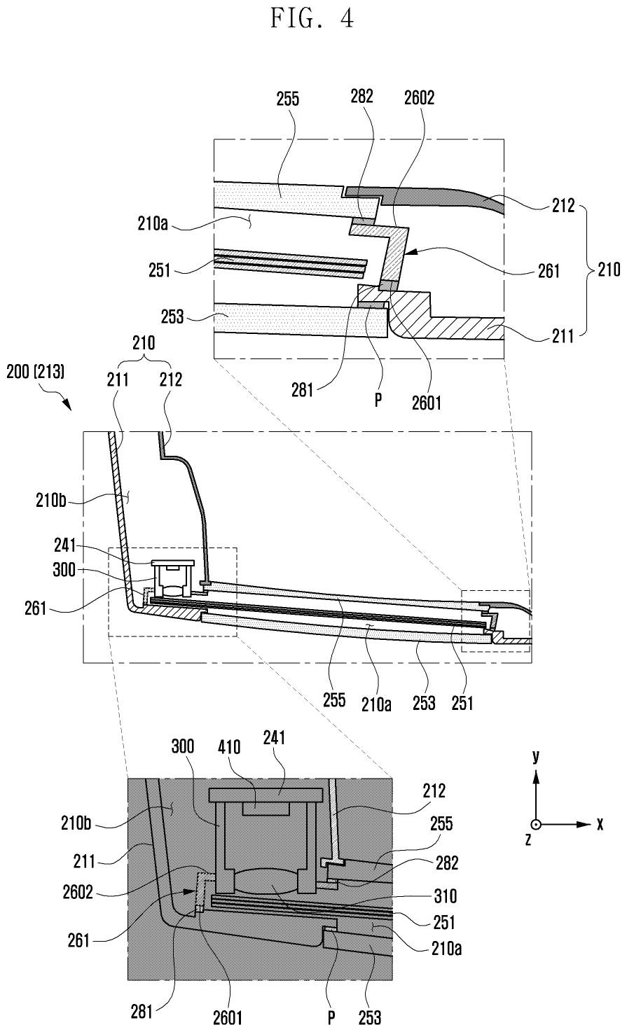

The wearable electronic device 200 (e.g., an electronic device) may include a housing 210 including a first rim housing 211, a second rim housing 212 coupled with the first rim housing 211, and a pair of temples 220 and 230 rotatably coupled at opposite ends of the housing 210. According to an embodiment of the disclosure, the housing 210 may be made of a material, such as polymer (e.g., plastic) for wearability. In some embodiments of the disclosure, the housing 210 may be made of various materials, such as metal, ceramic, or fiberglass reinforced plastic (FRP) (e.g., glass fiber reinforced plastic (GFRP) or carbon fiber reinforced plastic (CFRP)) considering weight, strength, or aesthetics. According to an embodiment of the disclosure, the housing 210 may be of an eyeglasses-type and may include a first rim 213 including a first opening 2101, a second rim 214 including a second opening 2102, and a bridge 215 connecting the first rim 213 and the second rim 214. According to an embodiment of the disclosure, the housing 210 may include a first end piece 216 provided at an end of the first rim 213 to be connected to a first temple 220 via a first hinge device 221, and a second end piece 217 provided at an end of the second rim 214 to be connected to a second temple 230 via a second hinge device 231. According to an embodiment of the disclosure, the wearable electronic device 200 may include a nose pad 218 disposed on at least a portion of the bridge 215 to rest on a user's nose. In some embodiments of the disclosure, the nose pad 218 may be integrated with the bridge 215. According to an embodiment of the disclosure, the wearable electronic device 200 may include a first optical unit 251 disposed to correspond to the first opening 2101 of the first rim 213 and a second optical unit 252 disposed to correspond to the second opening 2102 of the second rim 214. According to an embodiment of the disclosure, the first optical unit 251 may be disposed in a space (e.g., the first space 210a in FIG. 4) between a first front visor (e.g., the first front visor 253 in FIG. 3) and a first rear visor (e.g., the first rear visor 255 in FIG. 3) disposed through the first rim 213. According to an embodiment of the disclosure, the second optical unit 252 may be disposed in a space between a second front visor (e.g., the second front visor 254 in FIG. 3) and a second rear visor (e.g., the second rear visor 256 in FIG. 3) disposed through the second rim 214. According to an embodiment of the disclosure, the first optical unit 251 may include an optical lens (wave guide) having a total reflection condition for transmitting image information provided through the first display module 241 disposed on the first end piece 216 to the user. According to an embodiment of the disclosure, the second optical unit 252 may include an optical lens (wave guide) having a total reflection condition for transmitting image information provided through the second display module 242 disposed on the second end piece 217 to the user. According to an embodiment of the disclosure, the wearable electronic device 200 may be worn on the user's head in such a way that the first temple 220 and the second temple 230 are rested on the user's ears in the state of being unfolded, and the nose pad 218 is rested on the user's nose. In this case, the first optical unit 251 is positioned to correspond to the user's right eye, and the second optical unit 252 is positioned to correspond to the user's left eye, so that the image information provided from the first display module 241 and the second display module 242 can be output so that the user can view them. In some embodiments of the disclosure, the first temple 220 and the second temple 230 may be replaced with a hanging member designed to wrap at least a portion of the user's head. According to an embodiment of the disclosure, the hanging member may include various other wearing structures, such as straps or helmets, which are coupled to the housing 210 so as to be wearable on the head.

According to various embodiments of the disclosure, the wearable electronic device 200 may include smart glasses. For example, the wearable electronic device 200 may include wearable computer glasses that provide augmented reality by adding visual information to the foreground that is actually visible to the user. According to an embodiment of the disclosure, the augmented reality may provide various image information obtained by synthesizing virtual images onto preview images of real spaces or objects. For example, the wearable electronic device 200 may, in an augmented reality mode, synthesize a virtual image displayed on the first optical unit 251 and the second optical unit 252 with an actual visible foreground image and provide synthesized image to the user.

According to various embodiments of the disclosure, the first optical unit 251 and the second optical unit 252 may each include an optical waveguide that perform total internal reflection (TIR) of light provided from a corresponding one of light sources of the first display module 241 and the second display module 242. According to an embodiment of the disclosure, the optical waveguide may be made of, for example, glass or polymer, and may include a nano-pattern (e.g., a grating structure having a polygonal or curved shape) formed inside or on the surface. In some embodiments of the disclosure, the first display module 241 and the second display module 242 may each include a projector that projects light regarding an image onto corresponding one of the first optical unit 251 and the second optical unit 252. According to some embodiments of the disclosure, the first optical unit 251 and the second optical unit 252 may each include a see-through type transparent display. The see-through type transparent display may include, for example, a transparent organic light-emitting diode (OLED) display, a transparent micro LED, a transparent liquid crystal display (LCD), or a transparent thin-film electroluminescence (TFE) type.

According to various embodiments of the disclosure, the wearable electronic device 200 may include a first camera module 201, a plurality of second camera modules 202, audio modules 203, 204, and 205, a first substrate 206, a second substrate 207, a first battery 208, or a second battery 209. In some embodiments of the disclosure, the wearable electronic device 200 may include at least some of the components included in the electronic device 101 of FIG. 1, or may be implemented by additionally including other components. The positions or shapes of the components included in the wearable electronic device 200 are not limited to the examples illustrated in FIG. 2 and may be variously modified.

According to various embodiments of the disclosure, the first camera module 201 or the plurality of second camera modules 202 may include, for example, one or more lenses, image sensors, and/or image signal processors. In an embodiment of the disclosure, the first camera module 201 may be positioned on the bridge 215 and may acquire image data of the foreground (e.g., an actual image) in front of the eyes. The positions or number of first camera modules 201 is not limited to the illustrated example and may vary. In an embodiment of the disclosure, the plurality of second camera modules 202 may measure the depth of field (DOF). The wearable electronic device 200 may perform various functions, such as head tracking, hand detection or tracking, gesture recognition, or space recognition by using the depth of field (e.g., 3 degrees of freedom (DOF) or 6 DOF) obtained through the plurality of second camera modules 202. The plurality of second camera modules 202 may include, for example, a global shutter (GS) camera or a rolling shutter (RS) camera, and the positions or number thereof is not limited to the illustrated example and may vary.

According to various embodiments of the disclosure, the wearable electronic device 200 may include an eye tracking module. The eye tracking module may track the user's gaze using, for example, at least one of an electro-oculography or electrooculogram (EOG) sensor, a coil system, a dual Purkinje system, a bright pupil system, or a dark pupil system. The eye tracking module may include, for example, at least one camera (e.g., a micro camera or an IR LED) positioned in the housing (210) (e.g., the first rim 213, the second rim 214, or the bridge 215) to track the wearer's gaze.

According to various embodiments of the disclosure, the wearable electronic device 200 may include at least one light-emitting element (not illustrated). For example, the light-emitting element may provide the state information of the wearable electronic device 200 in the form of light. As another example, the light-emitting element may provide a light source that is linked to the operation of the camera module. The light-emitting element may include, for example, an LED, an IR LED, or a xenon lamp.

According to various embodiments of the disclosure, the audio modules 203, 204, and 205 may include, for example, a first audio module 203 for a microphone, a second audio module 204 for a first speaker, and a third audio module 205 for a second speaker. In an embodiment of the disclosure, the first audio module 203 may include a microphone hole formed in the bridge 215 of the housing 210, and a microphone positioned inside the bridge 215 corresponding to the microphone hole. The positions or number of first audio modules 203 for the microphone is not limited to the illustrated example and may vary. In some embodiments of the disclosure, the wearable electronic device 200 may detect the direction of sound using a plurality of microphones. In an embodiment of the disclosure, the second audio module 204 may include a first speaker positioned inside the first temple 220, and the third audio module 205 may include a second speaker positioned inside the second temple 230. The first speaker or the second speaker may be, for example, a piezo speaker (e.g., a bone conduction speaker) implemented without a speaker hole. The second audio module 204 for the first speaker or the third audio module 205 for the second speaker may be implemented in various other ways.

According to various embodiments of the disclosure, the first substrate 206 may be positioned inside the first temple 220, and the second substrate 207 may be positioned inside the second temple 230. The first substrate 206 and/or the second substrate 207 may include, for example, a printed circuit board (PCB), a flexible PCB (FPCB), or a rigid-flexible PCB (RFPCB). In some embodiments of the disclosure, the first substrate 206 or the second substrate 207 may include a primary PCB, a secondary PCB that is positioned to overlap the primary PCB, and/or an interposer substrate between the primary PCB and the secondary PCB. The first substrate 206 or the second substrate 207 may include various electronic components (e.g., at least some of the components included in the electronic device 101 in FIG. 1), such as a processor (e.g., the processor 120 of FIG. 1), memory (e.g., the memory 130 in FIG. 1), a communication module (e.g., the communication module 190 in FIG. 1), or an interface (e.g., the interface 177 in FIG. 1). The first substrate 206 or the second substrate 207 may be electrically connected to other components using electrical paths of, for example, a flexible printed circuit board or cable located within the housing 210. In some embodiments of the disclosure, one of the first substrate 206 and the second substrate 207 may be omitted.

According to various embodiments of the disclosure, the first battery 208 may be positioned inside the first temple 220, and the second battery 209 may be positioned inside the second temple 230. The first battery 208 and the second battery 209 are devices that supply power to the components of the wearable electronic device 200 (e.g., the battery 189 in FIG. 1), and may include, for example, a non-rechargeable primary battery, a rechargeable secondary battery, or a fuel cell. In some embodiments of the disclosure, the first battery 208 or the second battery 209 may be implemented to be detachable from the housing 210. In some embodiments of the disclosure, one of the first battery 208 and the second battery 209 may be omitted. The position or number of batteries 208 and 209 is not limited to the illustrated example and may vary.

According to various embodiments of the disclosure, the wearable electronic device 200 may include a sensor module (e.g., the sensor module 176 in FIG. 1). The sensor module may generate electrical signals or data values corresponding to the internal operating states or the external environmental states of the wearable electronic device 200. The sensor module may further include at least one of, for example, a gesture sensor, a gyro sensor, an atmospheric pressure sensor, a magnetic sensor, an acceleration sensor, a grip sensor, a color sensor, an infrared (IR) sensor, a biometric sensor (e.g., a heart rate monitor (HRM) sensor), a temperature sensor, a humidity sensor, or an illuminance sensor. In some embodiments of the disclosure, the sensor module may recognize the user's biometric information using various biometric sensors (or biometric recognition sensors), such as an e-nose sensor, an electromyography (EMG) sensor, an electroencephalogram (EEG) sensor, an electrocardiogram (ECG) sensor, or an iris sensor. In some embodiments of the disclosure, the sensor module may further include at least one control circuit for controlling at least one sensor included therein.

According to various embodiments of the disclosure, the wearable electronic device 200 may include an input module (e.g., the input module 150 in FIG. 1). The input module may include, for example, a touch pad or a button. The touch pad may recognize a touch input in at least one of, for example, a capacitive type, a pressure-sensitive type, an infrared type, and an ultrasonic type. The touch pad may further include a tactile layer, and may provide a tactile reaction to the user. The button may include, for example, a physical button, an optical key, or a keypad. The input module may include various other forms of user interfaces. In some embodiments of the disclosure, the input module may include at least one sensor module. In some embodiments of the disclosure, the button may be disposed on at least one of the temples 220 and 230, the rims 213 and 214, and/or the bridge 215.

According to various embodiments of the disclosure, the wearable electronic device 200 may include a connection terminal (e.g., the connection terminal 178 in FIG. 1). The connection terminal may include a connector through which the wearable electronic device 200 may be physically connected to an external electronic device (e.g., the external electronic device 102 or 104 in FIG. 1).

According to various embodiments of the disclosure, the wearable electronic device 200 may include at least one antenna (e.g., the antenna module 197 in FIG. 1). For example, the antenna may include a legacy antenna, a mmWave antenna, a near-field communication (NFC) antenna, a wireless charging antenna, and/or a magnetic secure transmission (MST) antenna. The antenna may perform, for example, long-distance or short-distance communication with an external device, or wireless transmission/reception of power for charging. In some embodiments of the disclosure, the antenna may be implemented using conductive unit portions arranged to be segmented through non-conductive split portions disposed on least a portion of the housing 210 or the temples 220 and 230 which are made of a conductive material.

FIG. 3 is an exploded perspective view of a wearable electronic device according to an embodiment of the disclosure.

Referring to FIG. 3, a wearable electronic device 200 may include a housing (e.g., the housing 210 in FIG. 2) and a pair of temples (e.g., the first temple 220 and the second temple 230 of FIG. 2) foldably disposed at opposite ends of the housing 210. According to an embodiment of the disclosure, the housing 210 may include a first rim housing 211 oriented in a first direction (e.g., the −y-axis direction) and a second rim housing 212 coupled with the first rim housing 211 and oriented in a second direction (e.g., the y-axis direction) opposite to the first direction. According to an embodiment of the disclosure, the housing 210 may include a pair of rims (e.g., the rims 213 and 214 in FIG. 2) and end pieces (e.g., the end pieces 216 and 217 in FIG. 2) extending from the respective rims 213 and 214 and configured to be coupled with the temples 220 and 230, for example, like a structure of eyeglasses, through the coupling of the first rim housing 211 and the second rim housing 212.

According to various embodiments of the disclosure, the wearable electronic device 200 may include a first bracket 261 disposed at a position corresponding to the first rim (e.g., the first rim 213 in FIG. 2) and a second bracket 262 disposed at a position corresponding to the second rim (e.g., the second rim 214 in FIG. 2) in a first space (e.g., the first space 210a in FIG. 4) between the first rim housing 211 and the second rim housing 212. According to an embodiment of the disclosure, the first bracket 261 and the second bracket 262 may be integrated to be connected to each other. According to an embodiment of the disclosure, the wearable electronic device 200 may include a first optical unit 251 disposed between the first bracket 261 and the first rim housing 211 and a second optical unit 252 disposed between the second bracket 262 and the first rim housing 211. According to an embodiment of the disclosure, the wearable electronic device 200 may include a first display module 241 and a second display module 242 disposed in a second space (e.g., the second space 210b in FIG. 4) provided through the first rim housing 211 and the second rim housing 212 to be adjacent to the first space (e.g., the first space 210a in FIG. 4). In some embodiments of the disclosure, the first display module 241 and the second display module 242 may be included in the first space 210a. According to an embodiment of the disclosure, at least a portion of the first display module 241 may be disposed to be supported by the first bracket 261 and to face at least a portion of the first optical unit 251. According to an embodiment of the disclosure, at least a portion of the second display module 242 may be disposed to be supported by the second bracket 262 and to face at least a portion of the second optical unit 252. For example, the first display module 241 and the second display module 242 may be disposed in an inner space (e.g., the second space 210b in FIG. 4) of the first end piece (e.g., the first end piece 216 in FIG. 2) and the second end piece (e.g., the second end piece 217 in FIG. 2) of the housing 210. In some embodiments of the disclosure, the first bracket 261 and the second bracket 262 may be made of a polymer (e.g., personal computer (PC)) material. In some embodiments of the disclosure, the first bracket 261 and the second bracket 262 may be formed of a metal material. In this case, the first bracket 261 and the second bracket 262 formed of a metal material may assist in the heat dissipation function of diffusing the heat generated from the first display module 241 and the second display module 242. According to an embodiment of the disclosure, the wearable electronic device 200 may include a first light refracting member 271 (e.g., a first prism) disposed between the first optical unit 251 and the first bracket 261 to deliver a light source of the first display module 241 to the first optical unit 251. According to an embodiment of the disclosure, the wearable electronic device 200 may include a second light refracting member 272 (e.g., a second prism) disposed between the second optical unit 252 and the second bracket 262 to deliver a light source of the second display module 242 to the second optical unit 252. According to an embodiment of the disclosure, the first light refracting member 271 and the second light refracting member 272 may have a refractive index to change the incident angle such that the light emitted from the light sources of the first display module 241 and the second display module 242 is incident on the first optical unit 251 and the second optical unit 252 at an angle of about 90 degrees. The first light refracting member 271 and the second light refracting member 272 may be made of a glass or transparent polymer material having a predetermined refractive index.

According to various embodiments of the disclosure, the wearable electronic device 200 may include a first front visor 253 fixed to the first rim housing 211 and a first rear visor 255 fixed to the second rim housing 212 at a position corresponding to the first rim (e.g., the first rim 213 in FIG. 2). According to an embodiment of the disclosure, the first optical unit 251 may be disposed in a space (e.g., the first space 210a of FIG. 4) between the first front visor 253 and the first rear visor 255. According to an embodiment of the disclosure, the wearable electronic device 200 may include a second front visor 254 fixed to the first rim housing 211 and a second rear visor 256 fixed to the second rim housing 212 at a position corresponding to the second rim (e.g., the second rim 214 in FIG. 2). According to an embodiment of the disclosure, the second optical unit 252 may be disposed in a space (e.g., the first space 210a of FIG. 4) between the second front second 254 and the first rear visor 256. According to an embodiment of the disclosure, the front visors 253 and 254 and the rear visors 255 and 256 may be formed to have a curved surface and made of a material that moves the focal distance to allow the user's naked eye E to confirm the image formed on the optical units 251 and 252. For example, the front visors 253 and 254 and the rear visors 255 and 256 may be made of transparent PC or glass.

According to various embodiments of the disclosure, the wearable electronic device 200 may have a sealing structure to protect the first optical unit 251 and the second optical unit 252 disposed in the inner space of the housing 210 from external foreign substances and/or moisture. According to an embodiment of the disclosure, the wearable electronic device 200 may include a first sealing member 281 disposed between the first rim housing 211 and the first bracket 261 and a second sealing member 282 disposed between the first bracket 261 and the first rear visor 255. According to an embodiment of the disclosure, the wearable electronic device 200 may include a third sealing member 283 disposed between the first rim housing 211 and the second bracket 262 and a fourth sealing member 284 disposed between the second bracket 262 and the second rear visor 256. The first, second, third, and fourth sealing members 281, 282, 283, and 284 may be compressible members and may be made of, for example, a material, such as compressible tape, sponge, silicone, rubber, or urethane. According to an embodiment of the disclosure, the wearable electronic device 200 may include a hermetic sealing space provided for the first optical unit 251 and the second optical unit 252 through the first, second, third, and fourth sealing members 281, 282, 283, and 284, the brackets 261 and 262, the first rim housing 211, and the first and second rear visors 255 and 256.

The wearable electronic device 200 according to various embodiments of the disclosure may include a sealing structure in which the sealing members 281, 282, 283, and 284 are disposed between the housing 210 and/or the visors (e.g., the rear visors 255 and 256) and the brackets 261 and 262 disposed in the inner space of the housing 210 (e.g., the first space 210a in FIG. 4), without direct involvement of the first optical unit 251 and the second optical unit 252, thereby minimizing deformation of the first optical unit 251 and the second optical unit 252 due to the arrangement of the sealing members 281, 282, 283, and 284, helping to reduce degradation of optical performance and improve assembly efficiency. Moreover, since the first optical unit 251 and the second optical unit 252 are supported at the side surfaces (e.g., the peripheries) through the brackets 261 and 262, the light leakage phenomenon may be prevented and firm support may be provided through the optical units 251 and 252.

FIG. 4 is a cross-sectional view of a portion of a wearable electronic device taken along line 4-4 of FIG. 2 according to an embodiment of the disclosure.

Referring to FIG. 4, the electronic device may include at least one of the components of the electronic device 101 illustrated in FIG. 1. In addition, the electronic device of FIG. 4 may be an electronic device having a similar form (e.g., a glasses-type electronic device) to the electronic device 200 illustrated in FIGS. 2 and 3. Unless otherwise stated, the components of the electronic device illustrated in FIG. 4 may be understood to be identical or similar to the components of FIGS. 2 and 3.

Hereinafter, the drawings specifically illustrate and describe the sealing structure disposed on the first rim (e.g., the first rim 213 in FIG. 2) of the wearable electronic device 200, but the sealing structure disposed on the second rim (e.g., the second rim 214 in FIG. 2) may also have substantially the same configuration. For example, the drawings below illustrate and describe the sealing structure for the first optical unit 251 disposed in the first space 210a defined by the first rim housing 211 and the second rim housing 212, but the sealing structure for the second optical unit 252 disposed in the first space 210a may also be substantially the same as the sealing structure for the first optical unit 251.

Referring to FIG. 4, a wearable electronic device 200 may include a housing (e.g., the housing 210 in FIG. 2) and a pair of temples (e.g., the first temple 220 and the second temple 230 of FIG. 2) foldably disposed at opposite ends of the housing 210. According to an embodiment of the disclosure, the housing 210 may include a first rim housing 211 and a second rim housing 212 coupled with the first rim housing 211. According to an embodiment of the disclosure, the housing 210 may include a pair of rims (e.g., the rims 213 and 214 in FIG. 2) and end pieces (e.g., the end pieces 216 and 217 in FIG. 2) extending from the respective rims 213 and 214 and configured to be coupled with the temples 220 and 230 through the coupling of the first rim housing 211 and the second rim housing 212.

According to various embodiments of the disclosure, the wearable electronic device 200 may include a first bracket 261 disposed at a position corresponding to the first rim (e.g., the first rim 213 in FIG. 2) in the first space 210a between the first rim housing 211 and the second rim housing 212. According to an embodiment of the disclosure, the first bracket 261 may include a first surface 2601 facing the first rim housing 211 and a second surface 2602 facing the second rim housing 212. According to an embodiment of the disclosure, the first bracket 261 may serve, in the inner space of the housing 210, as a partition wall that divides the first space 210a in which the first optical unit 251 is disposed and the second space 210b in which the first display module 241 is disposed. According to an embodiment of the disclosure, the first bracket 261 may include a support structure to support the first display module 241 disposed in the second space 210b. According to an embodiment of the disclosure, the wearable electronic device 200 may include a first optical unit 251 disposed between the first bracket 261 and the first rim housing 211 in the inner space of the housing 210. According to an embodiment of the disclosure, at least a portion (e.g., the periphery) of the first optical unit 251 may be disposed to be supported by the first rim housing 211 and/or the second rim housing 212. In some embodiments of the disclosure, at least a portion (e.g., the periphery) of the first optical unit 251 may be bonded to the first rim housing 211 and/or the second rim housing 212 via an adhesive member.

According to various embodiments of the disclosure, the wearable electronic device 200 may include a first sealing member 281 disposed between at least a portion of a first surface 2601 of the first bracket 261 and an inner surface of the first rim housing 211, and a second sealing member 282 disposed between at least a portion of a second surface 2602 of the first bracket 261 and the first rear visor 255. According to an embodiment of the disclosure, the first rear visor 255 may be coupled with the second rim housing 212 in a manner that closes the first opening (e.g., the first opening 2101 in FIG. 2). The first front visor 253 may also be coupled with the first rim housing 211 in a manner that closes the first opening (e.g., the first opening 2101 in FIG. 2). For example, the first front visor 253 and the first rear visor 255 may be bonded to the first rim housing 211 and the second rim housing 212, respectively, through adhesive members P. In some embodiments of the disclosure, the first front visor 253 and the first rear visor 255 may be bonded to the first rim housing 211 and the second rim housing 212, respectively, through a process, such as bonding, taping, or fusion. Accordingly, the wearable electronic device 200 may include a first space 210a provided by the first front visor 253 fixed to the first rim housing 211 and the first rear visor 255 fixed to the second rim housing 212. In this case, at least a portion of the first space 210a may be sealed by the first sealing member 281 disposed between the first surface 2601 of the first bracket 261 and the first rim housing 211 and the second sealing member 282 disposed between the second surface 2602 of the first bracket 261 and the first rear visor 255, thereby preventing the inflow of external foreign substances. In some embodiments of the disclosure, the first sealing member 281 may be disposed between the first surface 2601 of the first bracket 261 and the first front visor 253. In some embodiments of the disclosure, the second sealing member 282 may be disposed between the second surface 2602 of the first bracket 261 and the second rim housing 212.

The wearable electronic device 200 according to various embodiments of the disclosure includes a pair of rims (e.g., the first rim 213 and the second rim 214 in FIG. 2), and the sealing structure applied thereto is illustrated and described, but is not limited thereto. For example, it is obvious that the sealing structure according to various embodiments of the disclosure is applicable to a wearable electronic device including one rim or including three or more rims.

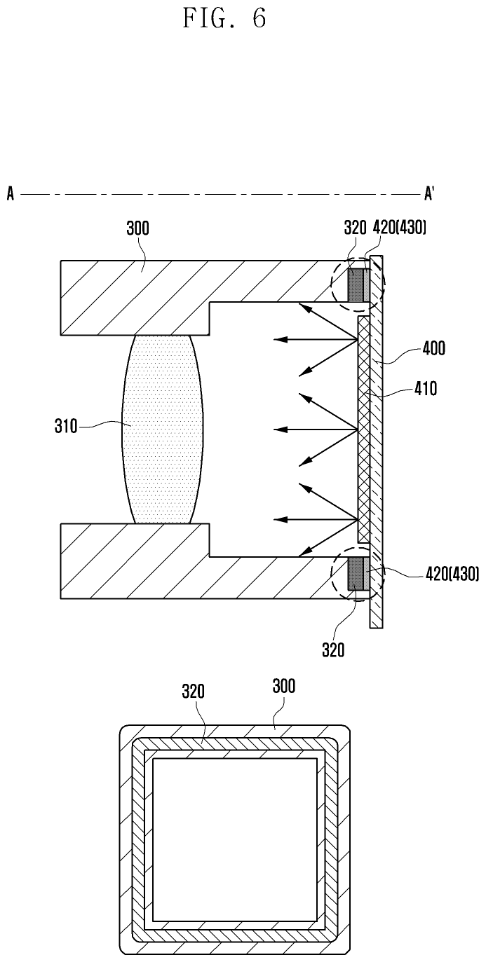

According to various embodiments of the disclosure, as illustrated in FIG. 4, a lens barrel 300 may be disposed between the first display module 241 and the first optical unit 251. The lens barrel 300 may be disposed in the inner space (e.g., the second space 210b) of the first end piece 216 together with the first display module 241. In some embodiments of the disclosure, the lens barrel 300 may be supported at least partially in the inner space of the first end piece 216 by the first bracket 261. The lens barrel 300 may be in close contact with the first display module 241 so that the light source generated from the first display module 241 does not leak out of the lens barrel 300. For example, referring to FIG. 6 which will be described below, the lens barrel 300 may be disposed on a substrate 400 of the first display module 241 to include a display area (active area) 410 where image information (or light source) is generated in the first display module 241. The lens barrel 300 may form a focus of the light source generated from the first display module 241 on the first optical unit 251 and may enlarge and project the image information generated from the first display module 241 on the first optical unit 251. In an embodiment of the disclosure, referring to FIG. 4, the lens barrel 300 may include a lens unit 310 (e.g., the first light refracting member 271 and the second light refracting member 272 in FIG. 3) that delivers the light source generated from the first display module 241 to the first optical unit 251. For example, the lens unit 310 may be disposed to face the first display module 241 and may guide the image information generated from the first display module 241 to the first optical unit 251.

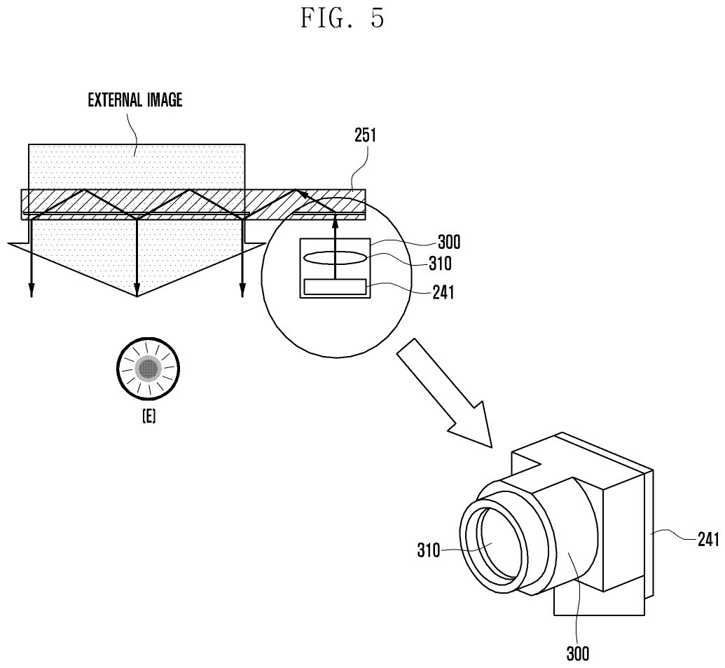

FIG. 5 is a view illustrating an implementation of augmented reality using a wearable electronic device according to an embodiment of the disclosure.

Referring to FIG. 5, hereinafter, the lens barrel 300 disposed in the first display module 241 is specifically illustrated and described below. The lens barrel 300 disposed in the second display module 242 may have substantially the same configuration as the lens barrel 300 disposed in the first display module 241.

According to various embodiments of the disclosure, referring to FIG. 5, the wearable electronic device 200 may implement augmented reality AR by combining external reality recognized through the optical units 251 and 252 and image information projected from the display modules 241 and 242. In an embodiment of the disclosure, the optical units 251 and 252 may include optical lenses having a total reflection condition for transmitting image information provided through the display modules 241 and 242 disposed on the end pieces 216 and 217 to the user's naked eye E. The optical units 251 and 252 may be positioned to correspond to the user's right eye and left eye, respectively. The user may visually recognize image information together with an external image as the image information output from the display module 241 and 242 is projected onto the optical units 251 and 252.

According to various embodiments of the disclosure, referring to FIG. 5, a lens barrel 300 may be disposed between the first optical unit 251 and the first display module 241. In an embodiment of the disclosure, referring to FIG. 4, the lens barrel 300 may be disposed in the inner space (e.g., the second space 210b in FIG. 4) of the first end piece 216 in which the first display module 241 is disposed. The lens barrel 300 may include a lens unit 310 (e.g., the first light refracting member 271 and the second light refracting member 272 in FIG. 3) that delivers the light source generated from the first display module 241 to the first optical unit 251. The lens unit 310 may have a refractive index for the light source generated from the first display module 241 to be incident on the first optical unit 251. The lens unit 310 may be made of a glass or transparent polymer material having a predetermined refractive index.

In an embodiment of the disclosure, the lens unit 310 may be a convex lens. In this case, the lens unit 310 may form a focus of the light source generated from the first display module 241 on the first optical unit 251. In addition, the lens unit 310 may magnify the image information generated from the first display module 241 and project it on the first optical unit 251.

According to various embodiments of the disclosure, the lens barrel 300 may be a barrel that surrounds the lens unit 310. The lens barrel 300 may block surrounding light to prevent light other than the light source generated from the first display module 241 from being projected onto the first optical unit 251. In an embodiment of the disclosure, referring to FIG. 6 which will be described below, the lens barrel 300 may be disposed on the first display module 241 to include a display area (active area) 410 where an image is displayed on the screen of the first display module 241. For example, the lens barrel 300 may be disposed on the substrate 400 of the first display module 241 to surround the display area 410. In an embodiment of the disclosure, the substrate 400 of the first display module 241 may be a bendable flexible printed circuit board (FPCB).

In an embodiment of the disclosure, the lens barrel 300 may be made of a material capable of ensuring a predetermined level of rigidity or higher. In an embodiment of the disclosure, the lens barrel 300 may be made of a polymer material (e.g., PC). In some embodiments of the disclosure, the lens barrel 300 may be made of a metal material. In this case, the lens barrel 300 made of a metal material may diffuse the heat generated from the first display module 241 to the surroundings.

According to various embodiments of the disclosure, the display modules 241 and 242 may need to maintain brightness at a predetermined level or higher in order to more clearly transmit the image information projected on the optical units 251 and 252. In order to implement a predetermined level of brightness or higher in the display modules 241 and 242, the intensity of the current applied to the display modules 241 and 242 may increase. Meanwhile, when the intensity of the current flowing in a wire connected to the pixels constituting the display areas 410 of the display modules 241 and 242 increases, the amount of voltage drop generated by wire resistance may increase. In this case, the driving voltage may be increased based on the voltage drop in order to maintain the brightness of the display modules 241 and 242. Therefore, the power consumption of the display modules 241 and 242 may increase.

Meanwhile, when a high level of brightness is implemented in the display modules 241 and 242, heat may be generated from the display modules 241 and 242. The heat generated from the display modules 241 and 242 may reduce the driving efficiency of the display modules 241 and 242. In the state in which the driving efficiency is reduced, the display modules 241 and 242 may require a higher driving voltage to maintain a predetermined level of brightness or higher. In this case, as the power consumption of the display modules 241 and 242 increases, the heat generation may increase.

In addition, the first display module 241 may generate heat in the display area 410 including a plurality of pixels. As described above, the display area 410 may be covered by the lens barrel 300. In this case, the heat generated in the display area 410 may not diffuse to the outside of the lens barrel 300 and may affect the physical properties of the lens unit 310.

According to various embodiments of the disclosure, the display modules 241 and 242 may implement brightness at a predetermined level or higher. According to an embodiment of the disclosure, a structure for reducing the heat generation in the display modules 241 and 242 may be proposed. The resistance of the display modules 241 and 242 may be reduced, for example, by increasing the width of a wire connected to the display modules 241 and 242. In addition, a structure may be proposed in which heat generated from the display modules 241 and 242 can be diffused to the surroundings. This will be explained below.

FIG. 6 illustrates a cross-sectional view taken along line A-A′ in FIG. 2 and a view illustrating a state in which a conductive member is disposed on a rear surface of a lens illustrated according to an embodiment of the disclosure.

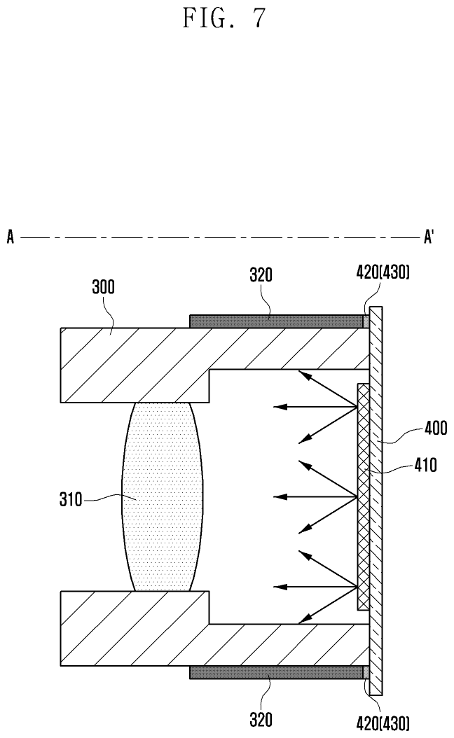

FIG. 7 is a cross-sectional view taken along line A-A′ in FIG. 2, in which a conductive member disposed on a side surface of a lens barrel is illustrated according to an embodiment of the disclosure.

Referring to FIG. 7, according to various embodiments of the disclosure, the lens barrel 300 may include a conductive member 320. In an embodiment of the disclosure, the conductive member 320 may be used as a portion of a power wire 420 for supplying power to pixels constituting the display area 410 of the first display module 241. The conductive member 320 may be disposed on one surface of the lens barrel 300 and electrically connected to the power wire 420 of the first display module 241. In an embodiment of the disclosure, the lens barrel 300 may include a front surface facing the first optical unit 251, a rear surface facing the first display module 241, a side surface that surrounds the front and rear surfaces. Referring to FIG. 6, the conductive member 320 may be disposed on the rear surface of the lens barrel 300. The lens barrel 300 may be disposed on the substrate 400 of the first display module 241 such that the conductive member 320 disposed on its rear surface is in contact with the power wire 420 disposed around the display area 410 of the first display module 241 and encloses the display area 410. In this case, as the power wire 420 of the first display module 241 is electrically connected to the conductive member 320, the same effect as physically widening the width of the power wire 420 can be achieved. As the resistance of the power wire 420 decreases, the voltage drop across the resistance may decrease. Accordingly, the compensation value for the driving voltage required to maintain the brightness of the first display module 241 may decrease. Therefore, the power consumption of the first display module 241 may decrease, and as the power consumption decreases, the heat generation of the first display module 241 may decrease.

In an embodiment of the disclosure, referring to FIG. 7, the conductive member 320 may be disposed on the side surface of the lens barrel 300. The lens barrel 300 may be disposed on the first display module 241 such that one end of the conductive member 320 disposed on its side surface is in contact with the power wire 420 disposed around the display area 410 of the first display module 241 and encloses the display area 410. In this case, as the power wire 420 of the first display module 241 is electrically connected to the conductive member 320, the same effect as physically widening the width of the power wire 420 can be achieved. As the resistance of the power wire 420 decreases, the voltage drop across the resistance decreases, and the compensation value for the driving voltage required to maintain the brightness of the first display module 241 may decrease. Therefore, the power consumption required to maintain the brightness of the first display module 241 may decrease, and as the power consumption decreases, the heat generation of the first display module 241 may decrease.

According to various embodiments of the disclosure, the conductive member 320 may have a greater width than the power wire 420 of the first display module 241. Since the power wire 420 is designed (e.g., deposited and etched) in the form of an integrated circuit on the substrate 400 of the first display module 241, there may be limitations in forming its thickness. The conductive member 320 may be formed to have a relatively thicker width than the power wire 420 of the first display module 241 as it is attached to the lens barrel 300. According to various embodiments disclosed herein, the resistance of the power wire 420 connected to the conductive member 320 may decrease as the width of the conductive member 320 increases, thereby reducing the voltage drop across the resistance. Therefore, the power consumption required to maintain the brightness of the first display module 241 may decrease, and as the power consumption decreases, the heat generation of the first display module 241 may decrease.

According to various embodiments of the disclosure, a conductive adhesive member may be disposed between the conductive member 320 and the power wire 420 of the first display module 241. The power wire 420 may be bonded to the conductive member 320 via the conductive adhesive member. In addition, the power wire 420 may be electrically connected to the conductive member 320 via the conductive adhesive member.

According to various embodiments of the disclosure, the conductive member 320 and the power wire 420 of the first display module 241 may be made of substantially the same material. In an embodiment of the disclosure, the conductive member 320 and the power wire 420 may be made of a metal material having low electrical resistance. For example, the conductive member 320 and the power wire 420 may be made of a material, such as aluminum (Al), titanium (Ti), tungsten (W), or a combination thereof.

According to various embodiments of the disclosure, the conductive member 320 may be used for various purposes other than the power wire of the first display module 241.

In an embodiment of the disclosure, the conductive member 320 may be electrically connected to a ground wire 430 of the first display module 241. In an embodiment of the disclosure, referring to FIGS. 6 and 7, the conductive member 320 may be electrically connected to the ground wire 430 rather than the power wire 420 of the first display module 241. Accordingly, the conductive member 320 may induce the flow of charges from the surroundings to the ground wire 430 having a relatively low potential.

In an embodiment of the disclosure, the conductive member 320 may be electrically connected to the first display module 241 to be used as a signal wire for the first display module 241.

For convenience of explanation, the above description was made under the assumption that the conductive member 320 of the lens barrel 300 is connected to the power wire 420 of the first display module 241. However, this may not limit the conductive member 320 to being connected only to the power wire 420. The conductive member 320 may be connected to various types of wires related to the first display module 241 to reduce the resistance of the wires. In an embodiment of the disclosure, the conductive member 320 may be connected to ground (e.g., the ground wire 430). Charges accumulated around the conductive member may move to the ground, which has a relatively low potential, through the conductive member 320.

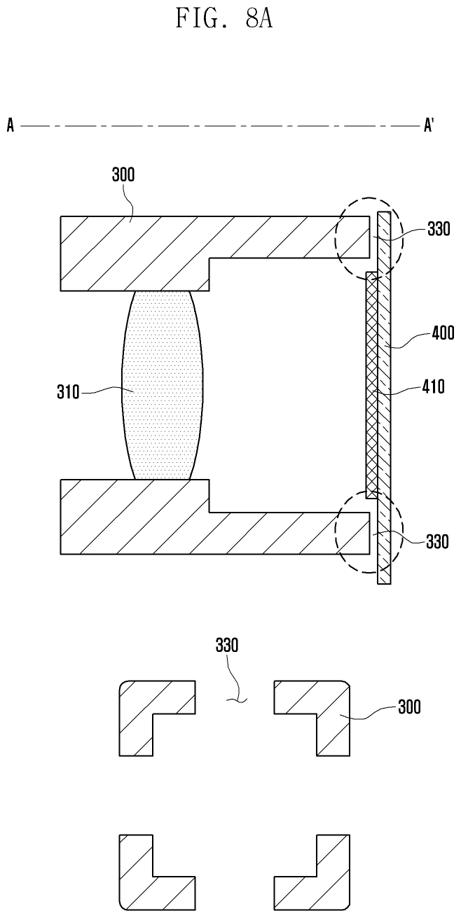

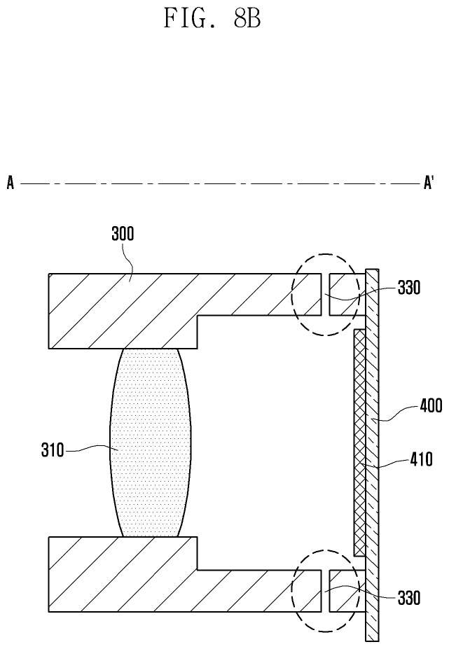

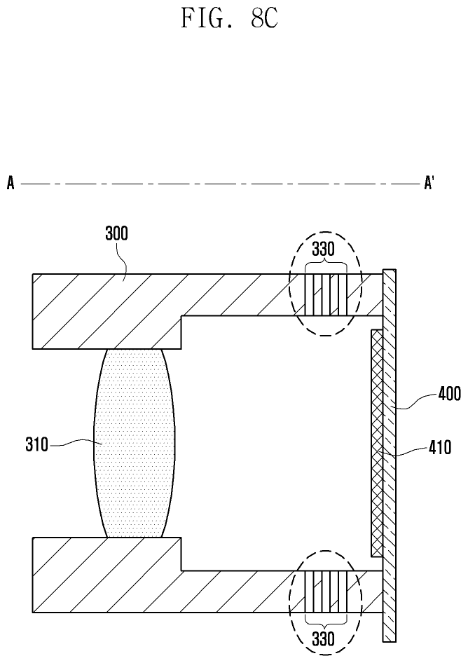

FIG. 8A a cross-sectional view taken along a line A-A′ in FIG. 2, and a plan view illustrating a rear surface of a lens barrel according to an embodiment of the disclosure.

FIGS. 8B and 8C are cross-sectional views taken along a line A-A′ in FIG. 2, illustrating a state in which holes are formed on a side surface of a lens barrel according to various embodiments of the disclosure.

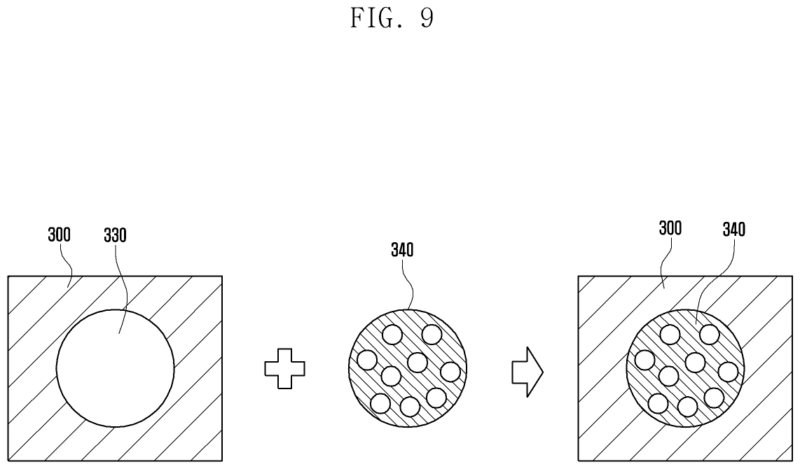

FIG. 9 illustrates a front view of a hole of a lens barrel and a view illustrating a state in which a porous material is disposed in a hole of a lens barrel according to an embodiment of the disclosure.

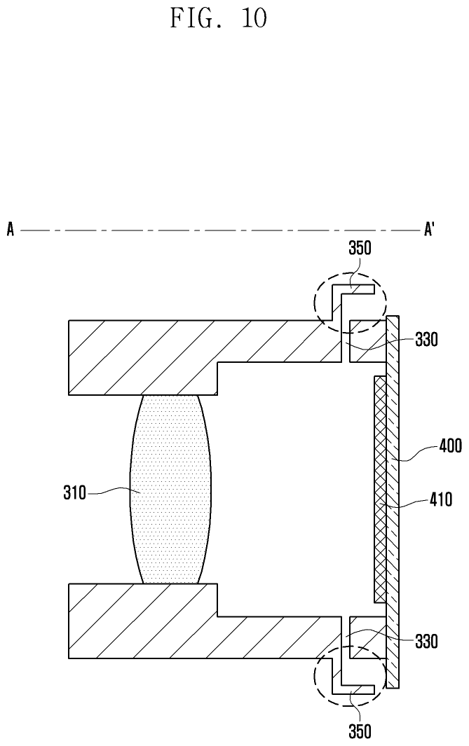

FIG. 10 is a cross-sectional view taken along a A-A′ in FIG. 2, illustrating a blocking member covering a hole of a lens barrel according to an embodiment of the disclosure.

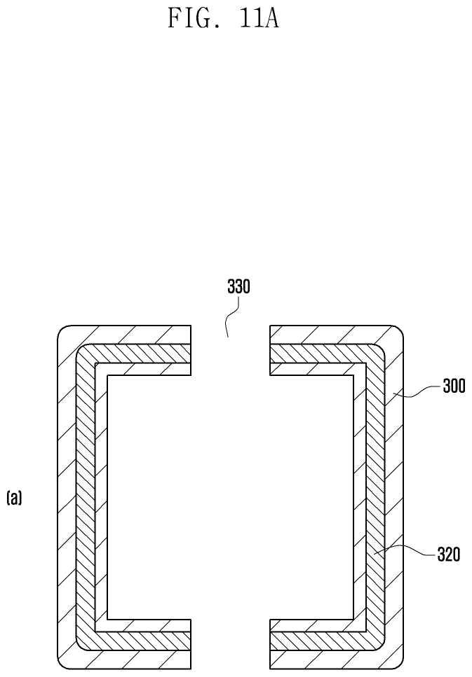

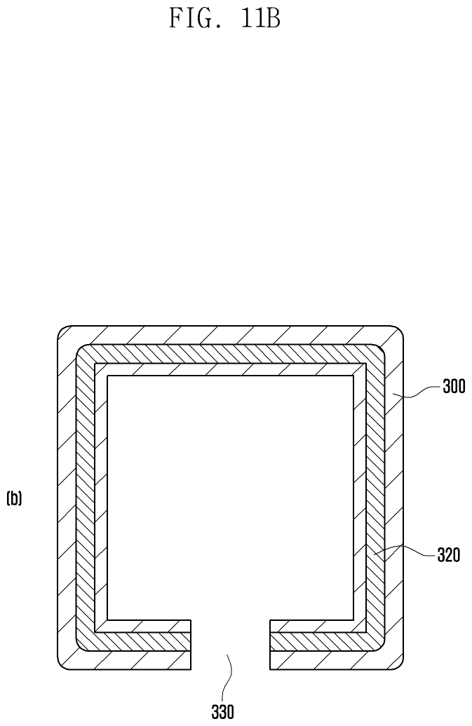

FIGS. 11A and 11B illustrate a plan view illustrating a rear surface of a lens barrel, and a view illustrating a state in which a conductive member is disposed on a rear surface of a lens barrel, and a hole is formed on a side surface of a lens barrel according to an embodiment of the disclosure.

Referring to FIGS. 8A, 8B, 8C, 9, 10, 11A, and 11B, according to various embodiments of the disclosure, the lens barrel 300 may include at least one hole 330 formed on a surface to connect the inside and the outside of the lens barrel 300. In an embodiment of the disclosure, referring to FIGS. 8A to 8C, the hole 330 may be formed on the side surface of the lens barrel 300. In an embodiment of the disclosure, referring to FIG. 8A, the hole 330 may be positioned between the lens barrel 300 and the substrate 400 of the first display module 241 and may be extended to the substrate 400. In an embodiment of the disclosure, referring to FIGS. 8B and 8C, the hole 330 may be formed on one side surface of the lens barrel 300. In an embodiment of the disclosure, one or more holes 330 may be provided. For example, multiple holes 330 may be provided. In an embodiment of the disclosure, heat generated in the display area 410 of the first display module 241 may diffuse from the inside of the lens barrel 300 to the outside of the lens barrel 300 through the hole 330. Therefore, the heat generation in the display area 410 of the first display module 241 may be reduced.

According to various embodiments of the disclosure, referring to FIG. 9, a porous material 340 may be disposed in the hole 330 of the lens barrel 300. In an embodiment of the disclosure, the porous material 340 may be a polymer material with multiple fine holes. The heat generated from the display area 410 of the first display module 241 may diffuse from the inside of the lens barrel 300 to the outside of the lens barrel 300 through the holes of the porous material 340. Therefore, the heat generation in the display area 410 of the first display module 241 may be reduced. In addition, since the holes of the porous material 340 are formed smaller than the hole 330 of the lens barrel 300, the phenomenon of foreign substances entering the inside of the lens barrel 300 through the hole 330 of the lens barrel may be alleviated.

According to various embodiments of the disclosure, referring to FIG. 10, the lens barrel 300 may include a blocking member 350 that blocks light or foreign substances from entering the hole 330. The blocking member 350 may be disposed around the hole 330 of the lens barrel 300 and face the hole 330. In an embodiment of the disclosure, the blocking member 350 may be integrated with the lens barrel 300. In some embodiments of the disclosure, the blocking member 350 may be provided separately from the lens barrel 300 and may be disposed on one surface adjacent to the hole 330 of the lens barrel 300. The blocking member 350 may block light or foreign substances outside the lens barrel 300 from entering the inside of the lens barrel 300 through the hole 330 of the lens barrel 300, thereby maintaining the quality of image information of the first display module 241 projected onto the first optical unit 251.

According to various embodiments of the disclosure, referring to FIGS. 11A and 11B, the lens barrel 300 may include a conductive member 320 and a hole 330 formed in one surface of the lens barrel 300. In an embodiment of the disclosure, referring to FIGS. 11A and 11B, the conductive member 320 may be disposed on the rear surface of the lens barrel 300 facing the first display module 241. In an embodiment of the disclosure, the number of holes 330 may be determined based on the degree of heat generated in the display modules 241 and 242. In an embodiment of the disclosure, at least one hole 330 may be formed in one surface of the lens barrel 300. In an embodiment of the disclosure, referring to FIG. 11A, the lens barrel 300 may be configured such that multiple holes 330 face each other. In some embodiments of the disclosure, the lens barrel 300 may include multiple holes 330, which are formed in adjacent surfaces, respectively. In an embodiment of the disclosure, referring to FIG. 11B, the lens barrel 300 may include a single hole 330. Therefore, the heat generated from the display modules 241 and 242 may be diffused to the outside of the lens barrel 300 through the hole 330.

According to an embodiment of the disclosure, the conductive member 320 illustrated in FIGS. 11A and 11B may be used as a portion of the power wire 420 of the first display module 241, as described above. In this case, the power wire 420 may be physically widened through the conductive member 320. Accordingly, the resistance of the power wire 420 may be reduced, thereby reducing the voltage drop across resistance. In addition, the power consumption of the first display module 241 may be reduced.

According to various embodiments disclosed herein, a wearable electronic device 200 (e.g., the electronic device 101 in FIG. 1) may include a housing 210 including at least one opening (e.g., the first opening 2101 and the second opening 2102 in FIG. 2), an optical unit 251 or 252 positioned in the at least one opening, a display module 241 or 242 configured to project, on the optical unit, image information, and a lens barrel 300 including a lens unit 310 (e.g., the first light refracting member 271 and the second light refracting member 272 in FIG. 3) disposed to face the display module so as to guide, to the optical unit, the image information generated from the display module, wherein the lens barrel is disposed between the optical unit and the display module; and a conductive member 320 disposed on one surface of the lens barrel to be electrically connected to a power wire 420 of the display module.

The conductive member may be disposed on the one surface of the lens barrel facing the display module and is in contact with the power wire of the display module.

The wearable electronic device may further include a conductive adhesive member disposed between the conductive member and the power wire of the display module.

The lens barrel may be disposed on the display module to include a display area (active area) 410 where the image information is displayed on the display module.

The lens barrel may include a front surface facing the optical unit, a rear surface facing the display module, and a side surface surrounding the front and rear surfaces, and the conductive member may be disposed on the side surface of the lens barrel.

The conductive member may be electrically connected to the ground 430 of the display module.

The conductive member may have a greater width than the power wire of the display module.

The housing may include an end piece extending in one direction from an end.

The display module and the lens barrel may be disposed in an inner space (e.g., the second space 210b in FIG. 4) of the end piece 216 or 217.

The wearable electronic device may further include a temple 220 or 230 rotatably connected to the end piece of the housing via a hinge device 221 or 231.

The lens unit of the lens barrel may be a convex lens.

According to various embodiments disclosed herein, a wearable electronic device 200 (e.g., the electronic device 101 in FIG. 1) may include a housing 210 including at least one opening (e.g., the first opening 2101 and the second opening 2102 in FIG. 2), an optical unit 251 or 252 positioned in the at least one opening, a display module 241 or 242 configured to project, on the optical unit, image information, and a lens barrel 300 disposed between the display module and the optical unit, the lens barrel including a lens unit 310 (e.g., the first light refracting member 271 and the second optical refracting member 272 in FIG. 3) disposed to face the display module and configured to guide the image information generated by the display module to the optical unit, and at least one hole 330 formed on one surface of the lens barrel.

The lens barrel may include a front surface facing the optical unit, a rear surface facing the display module, and a side surface surrounding the front and rear surfaces, and the hole of the lens barrel may be formed on the side surface of the lens barrel.

The hole of the lens barrel may have a porous material 340 disposed therein.

The wearable electronic device may further include a blocking member 350 disposed on one surface of the lens barrel and facing the hole of the lens barrel.

The lens barrel may be disposed such that the display module includes a display area (active area) 410 where the image information is displayed on the display.

In addition, the housing may include an end piece 216 or 217 extending in one direction from an end.

The display module and the lens barrel may be disposed in an inner space (e.g., the second space 210b in FIG. 4) of the end piece 216 or 217.

The wearable electronic device may further include a temple 220 or 230 rotatably connected to the end piece of the housing via a hinge device 221 or 231.

The lens unit of the lens barrel may be a convex lens.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a housing comprising at least one opening;
an optical unit positioned in the at least one opening;
a display module configured to project, on the optical unit, image information;
a lens barrel comprising a lens unit disposed to face the display module so as to guide, to the optical unit, the image information generated from the display module, wherein the lens barrel is disposed between the optical unit and the display module; and
a conductive member disposed on one surface of the lens barrel to be electrically connected to a power wire of the display module.

2. The wearable electronic device of claim 1,
wherein the conductive member is disposed on the one surface of the lens barrel facing the display module, and
wherein the conductive member is in contact with the power wire of the display module.

3. The wearable electronic device of claim 1, further comprising:
a conductive adhesive member disposed between the conductive member and the power wire of the display module.

4. The wearable electronic device of claim 1, wherein the lens barrel is disposed on the display module to comprise a display area (active area) where the image information is displayed on the display module.

5. The wearable electronic device of claim 1,
wherein the lens barrel comprises:
a front surface facing the optical unit,
a rear surface facing the display module, and
a side surface surrounding the front and rear surfaces, and
wherein the conductive member is disposed on the side surface of the lens barrel.

6. The wearable electronic device of claim 1, wherein the conductive member is electrically connected to ground of the display module.

7. The wearable electronic device of claim 1, wherein the conductive member has a greater width than the power wire of the display module.

8. The wearable electronic device of claim 1,
wherein the housing comprises an end piece extending in one direction from an end, and
wherein the display module and the lens barrel are disposed in an inner space of the end piece.

9. The wearable electronic device of claim 1, wherein the lens unit of the lens barrel is a convex lens.

10. A wearable electronic device comprising:
a housing comprising at least one opening;
an optical unit positioned in the at least one opening;
a display module configured to project, on the optical unit, image information; and
a lens barrel disposed between the display module and the optical unit, the lens barrel comprising a lens unit disposed to face the display module and configured to guide the image information generated by the display module to the optical unit, and at least one hole formed on one surface of the lens barrel.

11. The wearable electronic device of claim 10,
wherein the lens barrel comprises:
a front surface facing the optical unit,
a rear surface facing the display module, and
a side surface surrounding the front and rear surfaces, and
wherein the at least one hole of the lens barrel is formed on the side surface of the lens barrel.

12. The wearable electronic device of claim 11, wherein the at least one hole of the lens barrel has a porous material disposed therein.

13. The wearable electronic device of claim 10, further comprising:
a blocking member disposed on one surface of the lens barrel and facing the at least one hole of the lens barrel.

14. The wearable electronic device of claim 10, wherein the lens barrel is disposed on the display module to comprise a display area (active area) where the image information is displayed on the display module.

15. The wearable electronic device of claim 10,
wherein the housing comprises an end piece extending in one direction from an end, and
wherein the display module and the lens barrel are disposed in an inner space of the end piece.

16. The wearable electronic device of claim 10, further comprising:
a conductive member disposed on one surface of the lens barrel to be electrically connected to a power wire of the display module.

17. The wearable electronic device of claim 16,
wherein the conductive member is disposed on the one surface of the lens barrel facing the display module, and
wherein the conductive member is in contact with the power wire of the display module.

18. The wearable electronic device of claim 17, further comprising:
a conductive adhesive member disposed between the conductive member and the power wire of the display module.

19. The wearable electronic device of claim 16, wherein the conductive member is electrically connected to ground of the display module.

20. The wearable electronic device of claim 16, wherein the conductive member has a greater width than the power wire of the display module.
